(19) United States
(12) Patent Application Publication
(10) Pub. No.: US 2005/0220346 A1
(43) Pub. Date: Oct. 6, 2005

(54) Red eye detection device, red eye detection method, and recording medium with red eye detection program

(75) Inventor: Sadato Akahori, Kanagawa-ken (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/092,570

(22) Filed: Mar. 29, 2005

(30) Foreign Application Priority Data
Mar. 30, 2004 (JP) 099935/2004
Mar. 30, 2004 (JP) 099936/2004
Mar. 9, 2005 (JP) 064792/2005

(51) Int. Cl. G06K 9/00; G06K 9/46

(52) U.S. Cl. 382/190; 382/167

(57) ABSTRACT

A red eye detection device detects, from an image that contains the pupil of an eye having a red eye region, the red eye region. One or more red eye candidate regions that can be estimated to be the red eye region are first detected by identifying at least one of the features of the pupil from among features of the image. Then, at least one of the features of a face region with a predetermined size that contains the pupil is identified from a region containing only one of the red eye candidate regions detected by the red eye candidate detection section and wider than the one red eye candidate region. Then, the red eye candidate region is confirmed as a red eye region, based on a result of the identification. Information on the confirmed red eye candidate region is output as information on the detected red eye region.

### BACKGROUND OF THE INVENTION

1. Field of the Invention

The present invention relates generally to techniques of detecting a part that requires a local correction for colors of a photographic image, and more particularly to devices, methods, and programs for detecting red eye.

2. Description of the Related Art

If a flash photograph of a person or an animal is taken at night or in poor light, there are cases where the pupil of an eye (or part of the pupil) will be photographed as red or gold. For this reason, a variety of methods have been proposed in which the pupil photographed as red or gold is corrected to its original color by digital image processing.

For example, Japanese Unexamined Patent Publication No. 2000-013680 discloses a method and a device for automatically recognizing red eye from among regions specified by an operator, based on the color, position, and size of the pupil of an eye. Also, Japanese Unexamined Patent Publication No. 2001-148780 discloses a method of calculating a predetermined feature quantity of each pixel for a region specified by an operator and selecting as a correcting object a part that has the most distinguishing feature of the pupil. However, in the recognition process based on only features of the pupil, it is difficult to discriminate a locally reddish object such as a red electrical decoration from red eye. Because of this, it is difficult to automatically perform all operations without human intervention by an operator.

In contrast with this, a method of detecting red eye by a combination with a face detection process is disclosed in U.S. Pat. No. 6,252,976. This method can automatically detect red eye if it can accurately detect the face. However, in the case that a face is difficult to detect, such as a face in profile, a face covered with a hand or hair, it is also difficult to detect red eye without human intervention by an operator.

### SUMMARY OF THE INVENTION

The present invention has been made in view of the circumstances described above. Accordingly, the primary object of the present invention is to detect and correct red eye from an image with a high degree of accuracy without imposing a great burden an operator. To achieve this end, the present invention provides a red eye detection device, a red eye detection method, and a red eye detection program that are capable of accurately detecting red eye without human intervention. The present invention also provides a red eye detection device and a red eye detection program that have an operation support function of supporting an operator when detecting and retouching red eye.

An eye photographed as a color differing from its original color will hereinafter be referred to as red eye, including eyes other than red eyes.

A first red eye detection device of the present invention is a device for detecting, from an image that contains the pupil of an eye having a red eye region, the red eye region. The first red eye detection device comprises a red eye candidate detection section and a red eye decision section.

The red eye candidate detection section has the function of detecting one or more red eye candidate regions that can be estimated to be the red eye region, by identifying at least one of the features of the pupil from among features of the image.

The expression “identifying at least one of the features of the pupil” means that the identification process does not need to be performed based on all features of the pupil having a red eye region. That is, a red eye region maybe detected by using only a feature that is considered particularly effective in detecting the red eye region.

The red eye decision section has the function of identifying at least one of the features of a face region with a predetermined size that contains the pupil, from a region containing only one of the red eye candidate regions detected by the red eye candidate detection section and wider than the one red eye candidate region, and of deciding the red eye candidate region as a red eye region, based on a result of the identification.

The “face region with a predetermined size” is preferably a region that has a dimension of five times the red eye region contained in the face region, in at least one direction. The dimension of five times the red eye region is about a dimension from one corner of an eye to the other. That is, the face region with a predetermined size is preferably formed into a size that contains contours of an eye.

A red eye detection method of the present invention is a method of detecting, from an image that contains the pupil of an eye having a red eye region, the red eye region. In the red eye detection method, one or more red eye candidate regions that can be estimated to be the red eye region are first detected by identifying at least one of the features of the pupil from among features of the image.

Subsequently, at least one of the features of a face region with a predetermined size that contains the pupil is identified from a region containing only one of the detected red eye candidate regions and wider than the one red eye candidate region. Then, the red eye candidate region is decided as a red eye region, based on a result of the identification. And information on the red eye candidate region decided as a red eye region is output as information on the detected red eye region.

A first computer-readable recording medium of the present invention is a computer-readable recording medium having a red eye detection program, for causing a computer to carry out a process of detecting, from an image that contains the pupil of an eye having a red eye region, the red eye region, recorded therein.

The program further causes the computer to carry out: (1) a red eye candidate detection process of detecting one or more red eye candidate regions that can be estimated to be the red eye region, by identifying at least one of the features of the pupil from among features of the image; and (2) a red eye decision process of identifying at least one of the features of a face region with a predetermined size that contains the pupil, from a region containing only one of the detected red eye candidate regions and wider than the one red eye candidate region, and of deciding the red eye candidate region as a red eye region, based on a result of the identification. When this program is carried out by the computer, information on the red eye candidate region decided as a red eye region is output as information on the detected red eye region.

According to the above-described red eye detection device, red eye detection method, and red eye detection program, a red eye candidate region identified by making use of a feature of the pupil having a red eye region is identified again by making use of a feature of a wider region and is decided as a red eye region. Therefore, the possibility of an electrical decoration, which is not red eye, being contained in the detection result is reduced and the reliability of the detection result is enhanced.

The red eye candidate detection section or the red eye decision section preferably identifies the aforementioned feature in a color space that has an axis representing a color difference between red color and flesh color.

If the aforementioned feature is identified in a color space that has an axis representing a color difference between red color and flesh color, red eye can be accurately detected from a face in flesh color.

A second red eye detection device of the present invention is a device with a function of supporting an operation of detecting red eye from an image, in which at least part of the pupil of an eye is displayed red and a function of retouching the color of the red-eye. The second red eye detection device comprises three major components: (1) an automatic red eye detection section for automatically detecting the red-eye; (2) a degree of confidence calculation section for calculating a degree of confidence of a result of the detection of the red-eye obtained by the automatic red eye detection section; and (3) a process selection execution section for selecting and executing one process from among a plurality of processes, for obtaining a red eye retouched image, which are different in content of operation to be performed by a user. In the second red eye detection device, the process selection execution section selects a process in which an operation burden on the user is lower, as the degree of confidence becomes higher.

A second computer-readable recording medium of the present invention is a computer-readable recording medium having a red eye detection program, for causing a computer to carry out a process of supporting an operation of detecting red eye from an image, in which at least part of the pupil of an eye is displayed red, and an operation of retouching the color of the red-eye, recorded therein. The program further causes the computer to function as: (1) an automatic red eye detection section for automatically detecting the red-eye; (2) a degree of confidence calculation section for calculating a degree of confidence of a result of the detection of the red-eye obtained by the automatic red eye detection section; and (3) a process selection execution section for selecting and executing one process from among a plurality of processes, for obtaining a red eye retouched image, which are different in content of operation to be performed by a user. The process selection execution section is caused to function so as to select a process in which an operation burden on the user is lower, as the degree of confidence becomes higher.

The degree of confidence used herein is an index representing how accurately the judgment in red eye detection process is performed. For example, the judgment process by a computer is performed by comparing the value of a judging object with a predetermined threshold value. When a difference with the threshold value is great, the degree of self-confidence of the judgment is defined as a high degree of confidence. On the other hand, when the difference is small, it is defined as a low degree of confidence.

According to the aforementioned second red eye detection device and program, images requiring confirmation and images not requiring confirmation are automatically separated based on the degree of confidence of the detection process. Therefore, the workload of operators is considerably lightened.

The aforementioned process selection execution section provides the function of selecting and executing a process of requesting the user to perform an operation of confirming the detection result or retouched image, when the degree of confidence calculated by the degree of confidence calculation section is lower than a predetermined threshold value. The process to request the user to perform the confirmation operation may be a process of outputting a predetermined voice message.

In the case where the self-confidence is low and confirmation is needed, if a voice message is output to arouse a user's attention, users can perform the required confirmation by performing only the requested operation without checking whether confirmation is needed.

The aforementioned process selection execution section may select and execute a process of registering the image in a predetermined list, when the degree of confidence calculated by the degree of confidence calculation section is lower than a predetermined threshold value. In this case, users can perform confirmation at a later time.

If the aforementioned process selection execution section has the function of registering images in a list when the degree of confidence is low, it becomes possible to confirm information stored in the list at a later time and therefore user friendliness is enhanced.

### BRIEF DESCRIPTION OF THE DRAWINGS

The present invention will be described in further detail with reference to the accompanying drawings wherein:

FIG. 1 is a block diagram showing a red eye correction system that includes a red eye detection device, constructed in accordance with a first embodiment of the present invention, and a red eye retouch device;

FIG. 2 is a flowchart showing a red eye candidate detection process to be performed by the red eye candidate detection section of the red eye detection device shown in FIG. 1;

FIG. 3 is a diagram used to explain resolution-classified images;

FIG. 4, which includes FIGS. 4A and 4B, is a diagram showing an object range set process and a red eye region identification process;

FIG. 5, which includes FIGS. 5A, 5B, and 5C, is a diagram showing samples used in a learning operation by a red eye candidate detector;

FIG. 6 is a flowchart showing the identification process of the red eye candidate detection process of FIG. 2;

FIG. 7 is a diagram used to explain a candidate regulation process;

FIG. 8 is a flow chart showing a red eye decision process to be performed by the red eye decision section of the red eye detection device shown in FIG. 1;

FIG. 9 is a diagram used to explain a trimming process;

FIG. 10 is a diagram showing an example of a trimmed region on which an eye identification process is performed;

FIG. 11, which includes FIGS. 11A to 11E, is a diagram showing an eye sample used in a learning operation by an eye detector;

FIG. 12, which includes FIGS. 12A and 12B,is a diagram showing another example of the trimmed region on which the eye identification process is performed;

FIG. 13 is a diagram showing an overview of the processing by the red eye retouch device shown in FIG. 1;

FIG. 14 is a flowchart showing a red eye detection-retouch process to be performed according to a second embodiment of the present invention;

FIG. 15 is a flowchart showing the process of confirming images that are registered in a list;

FIG. 16 is a flowchart showing a red eye detection process to be performed according to a third embodiment of the present invention;

FIG. 17 is a flowchart showing the process of confirming detection results that are registered in the list;

FIG. 18 is a flowchart showing a red eye retouch process to be performed by the second image processing device of the third embodiment; and

FIG. 19 is a flowchart showing a red eye detection process and red eye retouch process to be executed by a digital camera constructed in accordance with a fourth embodiment of the present invention.

### DESCRIPTION OF THE PREFERRED EMBODIMENTS

Preferred embodiments of the present invention will hereinafter be described in reference to the drawings.

### First Embodiment

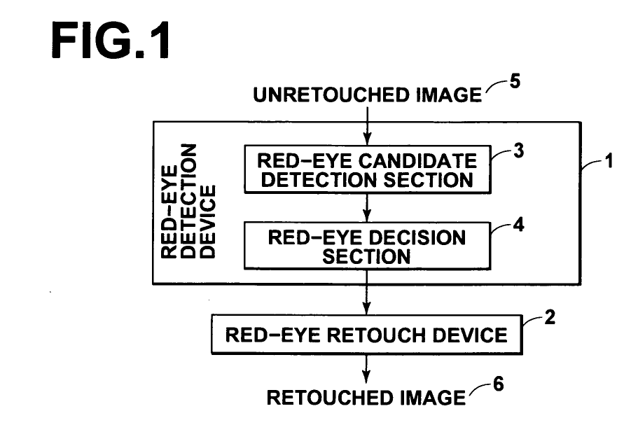

Referring to FIG. 1, there is shown a system for correcting red eye. This system includes a red eye detection device 1 that is constructed according to a first embodiment of the present invention, and a red eye retouch device 2 that performs a local color correction on an image so that the color of a red eye region detected by the red eye detection device 1 becomes the original color of the pupil of an eye. As shown in the figure, the red eye detection device 1 comprises a red eye candidate detection section 3 for detecting a red eye candidate that is estimated to be red eye from an unretouched image, and a red eye decision section 4 for checking whether a candidate region detected is a true red eye region and deciding a red eye region. The red eye retouch device 2 refers to information on a red eye region decided by the red eye decision section 4 of the red eye detection device 1, then retouches the color of the red eye region, and outputs a retouched image 6.

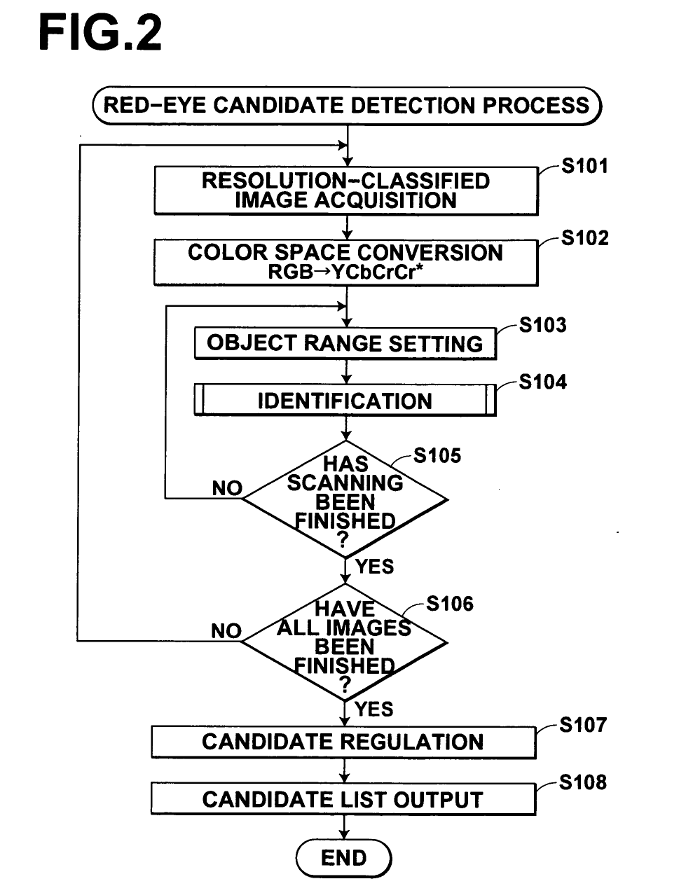

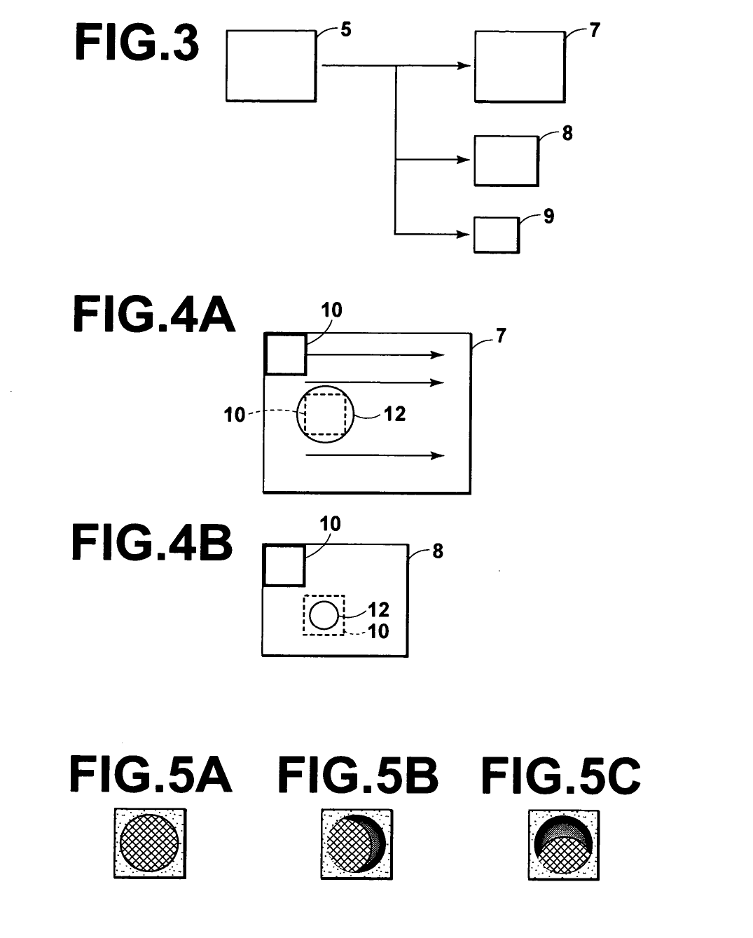

FIG. 2 shows the red eye candidate detection process to be performed by the red eye candidate detection section 3 of the red eye detection device 1 shown in FIG. 1. The red eye candidate detection section 3 first acquires a resolution-classified image (S101). FIG. 3 is a diagram used to explain a resolution-classified image. As shown in the figure, in the first embodiment, a first image 7 with the same resolution as that of the unretouched image 5, a second image 8 with resolution one-half that of the unretouched image 5, and a third image 9 with resolution one-fourth that of the unretouched image 5 are previously generated and stored in memory.

The first image 7 with the same resolution as the unretouched image 5 is generated by copying the unretouched image 5. On the other hand, the second and third images 8, 9 different in resolution from the unretouched image 5 are generated by performing a pixel thinning-out process (in which the number of pixels is reduced) on the unretouched image 5. In step S101 of FIG. 2, the red eye candidate detection section 3 acquires one of the resolution-classified images 7 to 9 by reading out it from memory.

The red eye candidate detection section 3 then performs a color space conversion process on the acquired resolution-classified image (S102). More specifically, the red eye candidate detection section 3 converts the color system of the resolution-classified image by converting the values of the red (R), green (G), and blue (B) components of each pixel that constitutes the resolution-classified image to the values of Y (luminance), C_{b} (color difference between G and B), Cᵣ (color difference between G and R), and Cᵣ* (color difference between G and R) components, using a predetermined conversion equation.

The Y, C_{b}, and Cᵣ components are a typical coordinate system used in Joint Photographic Experts Group (JPEG) images and Cᵣ* is a coordinate axis representing a direction where red color and flesh color are separated best from each other in the RGB space. The direction of the coordinate axis is previously determined by applying a linear discriminant method to red and flesh color samples. If such a coordinate axis is defined, detection accuracy for red eye candidate regions to be described later can be enhanced compared with the case where detection is performed in the YC_{b}Cᵣ space.

Subsequently, the red eye candidate detection section 3 sets a judging-object range over an image on which the color space conversion process is performed (S103). The red eye candidate detection section 3 then performs a red eye candidate region identification process on the judging-object range (S104) The judging-object range set process in step S103 and the red eye candidate region identification process in step S104 are shown in FIG. 4.

FIG. 4A shows the state in which a judging-object range 10 is set over the resolution-classified image 7 on which the color space conversion process has been performed in step 102. In the first embodiment, the judging-object range 10 is a region of 13 pixelsλ13 pixels, but for the convenience of explanation, it is shown on an enlarged scale.

In the identification process, an image contained in the set judging-object range 10 is detected by a plurality of red eye candidate detectors. And from a combination of detection results obtained by the detectors, it is judged whether the image in the judging-object range 10 can be estimated to be a red eye region. If it can be estimated to be red eye, that region is detected as a red eye candidate region.

The red eye candidate detector refers to a combination of (1) a parameter for calculating a feature quantity that is effective in discriminating between a red eye and a non-red eye, (2) an identifier for outputting an identification point that represents a probability of red eye with the calculated feature quantity as input, and (3) a threshold value determined to maintain a predetermined accurate detection ratio by applying the parameter and identifier to a great number of red-eye samples and then calculating the value of the accumulated identification point.

The aforementioned parameter and identifier are determined by previously performing learning, using a great number of red-eye samples and non-red eye samples. Learning can be performed by employing well-known methods such as a neural network method known as a machine learning technique, a boosting method, etc.

Samples to be used in learning preferably include a predetermined variation in the size of a red region relative to a unit rectangle, such as a sample with a red region of 100% of the pupil, a sample with a red region of 80% of the pupil, and a sample with a red region of 60% of the pupil, as shown in FIGS. 5A, 5B, and 5C.

If samples for learning contain samples in which the center of a red region is shifted from the center of a unit rectangle, even red regions with a shifted center can be extracted. Therefore, even if the spacing between samples is made wider when setting a judging object range over an image and scanning the image with the range, accuracy of extraction can be maintained and processing time can be shortened.

The aforementioned threshold value is preferably determined so as to perform accurate detection in a predetermined probability or greater, by applying the feature-quantity calculating parameters and identifiers determined by a learning operation to as many red-eye samples as possible and calculating the value of the accumulated identification point.

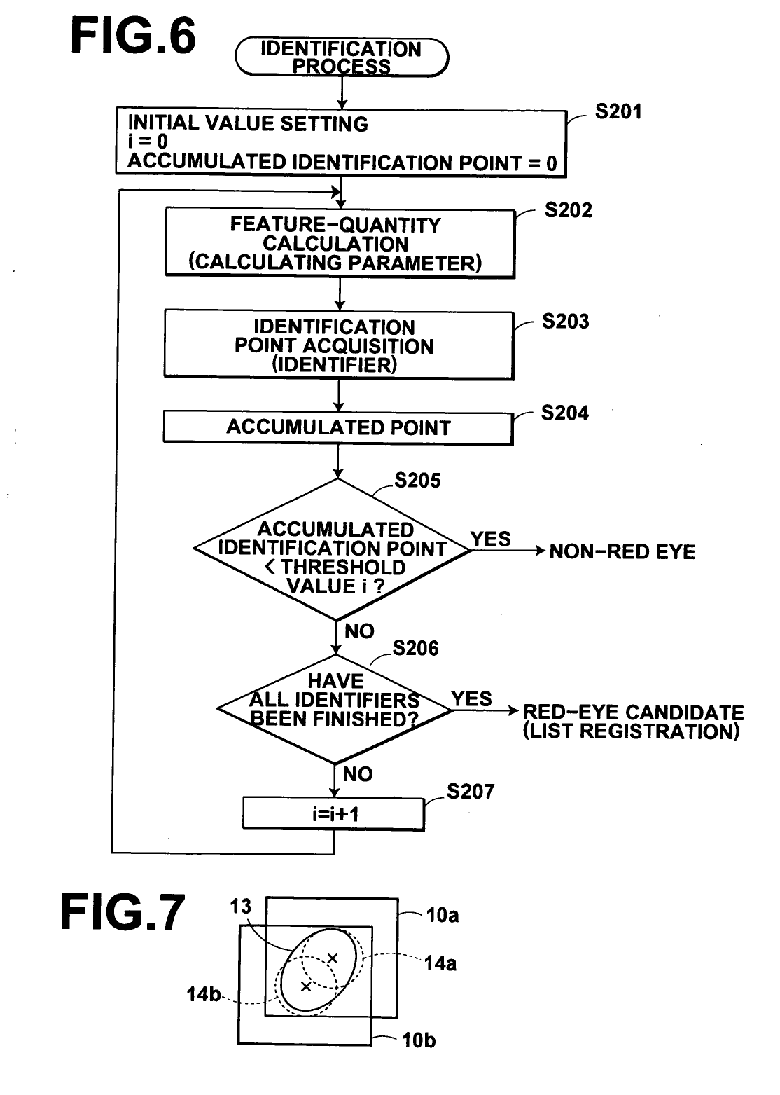

FIG. 6 is a flowchart showing the essential processing steps of the identification process performed in step S104 of FIG. 2. In the flowchart, a letter “i” is used to identify a red eye candidate detector. In the case of N red eye candidate detectors, the letter “i” changes from 0 to N−1(0≦i≦N−1). N red eye candidate detectors, that is, parameter i, identifier i, and threshold value i (0≦i≦N−1) are stored in memory, a hard disk, etc.

Initially, the values of the letter i and accumulated identification point are initialized to zero (S201). Then, a feature quantity of the aforementioned judging-object range 10 is calculated by using the feature-quantity calculating parameter i, and the result of calculation is obtained (S202) Then, an identification point is obtained by referring to an identifier i, based on the result of calculation (S203). The identification point is added to the accumulated identification point (S204). Then, the accumulated identification point is compared with the threshold value i (S205). At this stage, if the accumulated identification point is less than the threshold value i, an image within the judging-object range 10 is judged to be a non-red eye.

On the other hand, if the accumulated identification point exceeds the threshold value i, whether processing has been finished for all identifiers is judged by judging whether i is N−1 (S206). When i is less than (N−1), i is increased by 1 (S207). Similarly, steps S202 to S207 are repeated. When processing has been finished for all identifiers (S206), an image within the judging-object range 10 is judged a red eye candidate region and is registered in a candidate list.

In the first embodiment, the feature-quantity calculating parameter comprises channels (Y, C_{b}, Cᵣ, and Cᵣ*) to be referred to, feature-quantity type (pixel value itself, two-point difference, and four-point difference), and coordinates, within a judging-object range, of a pixel to be referred to.

The above-described identification process is repeatedly carried out while moving the judging-object range 10 little by little, as shown by arrows in the image 7 of FIG. 4. The setting of the judging-object range 10 and the identification process are finished when it is judged in step S105 of FIG. 4 that scanning has been finished.

In step S106 of FIG. 2, the red eye candidate detection section 3 judges whether processing has been finished for all resolution-classified images 7 to 9. If other resolution-classified images have not yet been processed, the red eye candidate detection process returns to step S101. In step S101, the next resolution-classified image 8 is acquired and the detection process is repeated.

That the above-described detection process is repeatedly performed on images different in resolution is for the following reasons. FIG. 4B shows the state in which the judging-object range 10 is set over the second image 8 lower in resolution than the first image 7. The judging-object range 10 is 13 pixels×13 pixels in size, as previously described. If resolution is made lower, the judging-object range 10 contains a wider range, compared with the case where resolution is high.

For example, as shown in FIGS. 4A and 4B, when the image of a pupil 12 is contained in the first image 7, there are cases where the pupil 12 not detected in the identification process performed on the first image 7 of FIG. 4A can be detected in the identification process performed on the second image 8 lower in resolution than the first image 7. When a red eye candidate region is detected, the information on the resolution of that image is stored in memory, etc. Reference to that information is made by the red eye decision section 4 to be described later.

If it is judged in step S106 that processing has been finished for all resolution-classified images 7 to 9, the red eye candidate detection section 3 carries out a candidate regulation process (S107). FIG. 7 is a diagram used for explaining the candidate regulation process. As shown in the figure, in the above-described object range set process and identification process, there are cases where a single red eye region is detected as two red-eyes regions.

For example, when a red eye region is an elliptic region 20 shown in FIG. 7, there are cases where a region 14a is judged as a red eye candidate region in the identification process performed on a judging-object region 10a and a region 14b is judged as a red eye candidate region in the identification process performed on a judging-object region 10b. In such a case, the candidate regulation process is the process of leaving as a red eye candidate region only one of the two red eye candidate regions 14a and 14b that has a higher identification point, and deleting the other red eye candidate region from the candidate list.

The red eye candidate detection section 3 outputs as a red eye candidate list the center coordinates and size of a red eye candidate finally left by the above-described red eye candidate detection process.

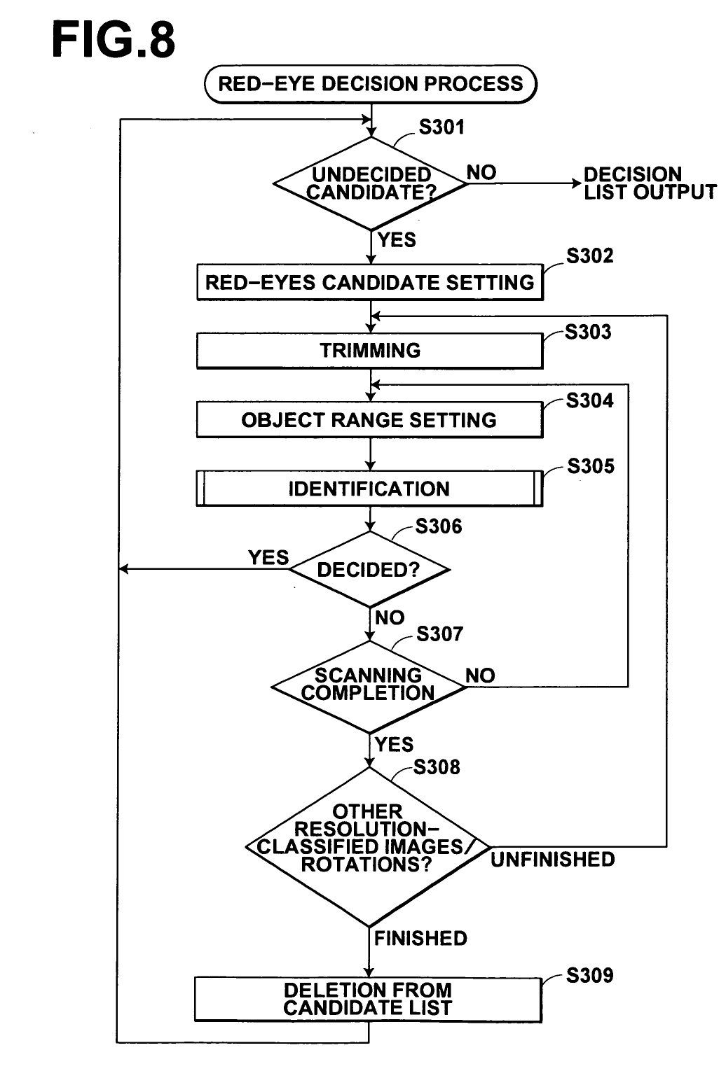

Subsequently, a red eye decision process by the red eye decision section 4 of FIG. 1 will be described. FIG. 8 shows the red eye decision process. The red eye decision section 4 performs the decision process in order on each of the red eye candidate regions contained in the red eye candidate list output by the red eye candidate detection section 3. The red eye decision process is repeated until it is judged in step S301 that there is no undecided red eye region.

One red eye candidate region is first selected from the red eye candidate list and undergoes the decision process (S302). Subsequently, an image containing the selected red eye candidate region is trimmed (S304).

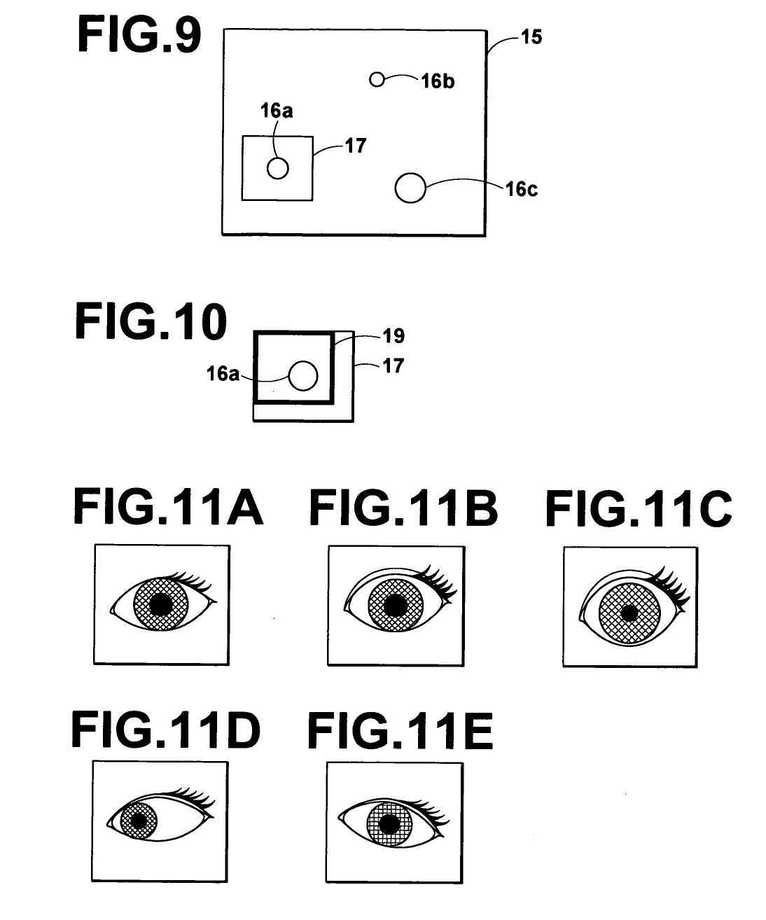

FIG. 9 is a diagram used for explaining a trimming process. For example, in the figure, three red eye candidate regions 16a, 16b, and 16c detected by the red eye candidate detection section 3 are shown. In this example, the red eye candidate region 16a is selected and undergoes the trimming process.

The trimming process is performed on an image 15 that has the same resolution as that of an image containing the red eye candidate region 16a detected in the red eye candidate detection process. Also, when the red eye candidate region 16a is estimated to be the pupil of an eye, a region 17 containing the entire eye that has the pupil is trimmed. The region 17 containing the entire eye is a region containing the upper eyelid to the lower eyelid and both corners of the eye. In other words, it is a region containing all contours of an eye.

Next, as shown in FIG. 10, a judging-object region 19 is set within the trimmed region 17 and undergoes an eye identification process (S305).

In the eye identification process, an image contained in the judging-object region 19 is detected by a plurality of eye detectors, and from a combination of the detection results obtained by the eye detectors, it is judged whether the image contained in the judging-object region 19 is an eye. When it is judged an eye, the red eye candidate region 16a in the eye is decided as a red eye region.

The eye detector refers to a combination of (1) a parameter for calculating a feature quantity that is effective in discriminating between an eye and an object other than eyes, (2) an identifier for outputting an identification point that represents a probability of an eye with the calculated feature quantity as input, and (3) a threshold value determined to maintain a predetermined accurate detection ratio by applying the parameter and identifier to a great number of eye samples and then calculating the value of the accumulated identification point.

The aforementioned parameter and identifier are determined by previously performing learning, using a great number of eye samples and samples representing an object other than eyes. Learning can be performed by employing well-known methods such as a neural network method known as a machine learning technique, a boosting method, etc.

Samples to be used in learning preferably include variations such as an eye with a single eyelid, an eye with a double eyelid, an eye with a small pupil, etc., as shown in FIGS. 11A, 11B, and 11C. In addition, as shown in FIG. 1D, an eye with a pupil shifted from the center may be included as an eye sample. Furthermore, a slightly inclined eye such as the one shown in FIG. 11E may be included as an eye sample so that an obliquely arranged eye can be identified. In the first embodiment, learning has been performing by employing samples different in angle of inclination in the range of −15 degrees to 15 degrees. In addition, learning may be performed by preparing samples that are different in a ratio of an eye region to the entire region.

The processing steps of the eye identification process are the same as those of the red eye candidate region identification process shown in FIG. 6. However, an eye may be identified by a method differing from the red eye candidate region identification process, such as a method of extracting a feature about an edge or texture, using Wavelet coefficients.

The eye identification process is repeatedly carried out while moving the judging-object range 19 little by little within the trimmed region 17 of FIG. 10. Since the trimmed region 17 is a region cut out with the red eye candidate region 16a center, an eye with that region as the pupil is normally detected, but there are cases where the pupil is shifted from the center. For that reason, the first embodiment acquires the accurate position of the pupil by movement of the judging-object range 19.

As shown in step S306 of FIG. 8, the setting of the judging-object range 19 and the identification process are finished, when an eye is detected and the red eye candidate region 16a is decided as a red eye region. When it cannot not decided and scanning of the trimmed region 17 has not yet been finished, the decision process returns to step S304 and the judging-object range 19 is reset. Then, the identification process is carried out again.

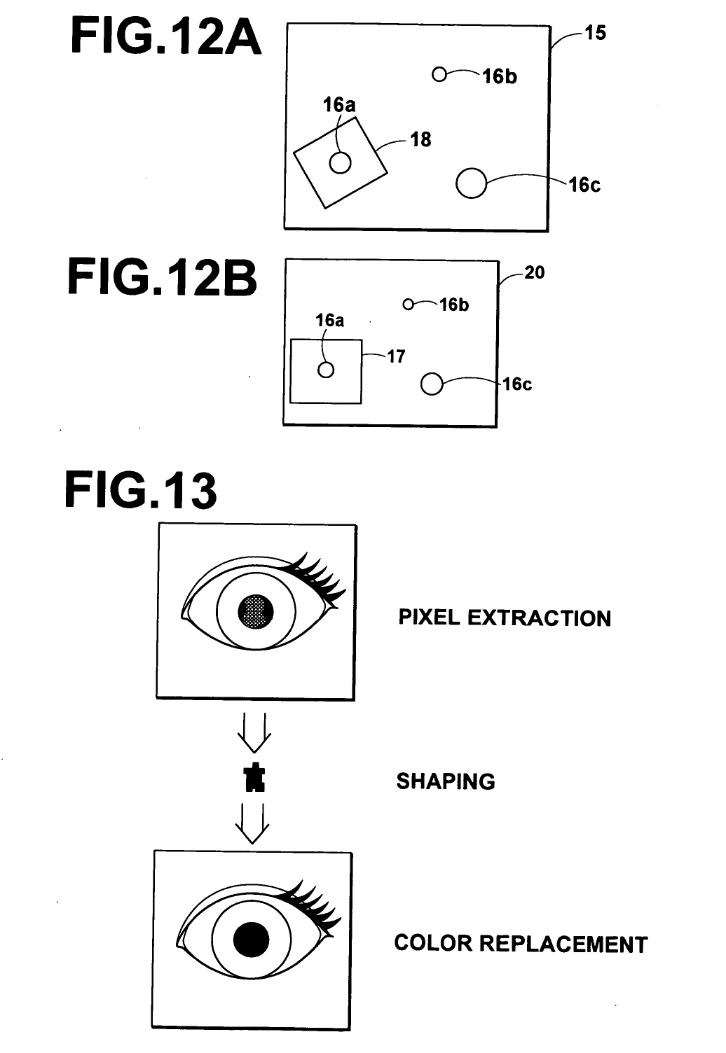

When no eye is detected until scanning of the trimmed region 17 is finished (S307), a region 18 is trimmed by rotating the trimmed region 17 on the red eye candidate region 16a, as shown in FIG. 12A. Features of an eye are greatly different in the up-and-down direction and right-and-left direction. Therefore, when an eye is obliquely arranged, there is a possibility that no eye will be detected, even if the identification process is performed on the trimmed region 17 shown in FIG. 9.

In the first embodiment, the trimmed region is rotated at intervals of 30 degrees. That is, the aforementioned identification process is performed on the trimmed region inclined at 30 degrees (or −30 degrees). And if no eye is detected, the trimmed region is further rotated 30 degrees (−30 degrees) and the identification process is repeated.

Inclined eyes can be detected by previously performing learning, using eye samples that have all angles of inclination. However, in the first embodiment, in consideration of accuracy of detection and processing time, eyes inclined in the range of −15 degrees to 15 degrees are identified by learning. And eyes inclined at angles greater than that range are identified by rotating the trimmed region.

The aforementioned trimming process, object range set process, and identification process may be performed on an image 20 slightly different in resolution from the image 15, as shown in FIG. 12A. When changing resolution, it is finely adjusted by obtaining 2-¼ times resolution, 2-¼ times (2-¼ times resolution), etc., unlike the case of red eye candidate detection. When no eye is detected even if other resolutions and rotation angles are employed, the red eye candidate region 16a is deleted from the candidate list (S308) and the identification process is repeated on the next candidate region of the red eye candidate list.

In the first embodiment, the red eye candidate detection section 3 performs the identification process based on only features of the pupil of an eye, so there is a possibility that the red eye candidate list will contain a red electrical decoration, etc., as red eye candidate regions. However, since the eye identification process can reliably detect eyes making use of information on a white, an eyelid, eyelashes, etc., the reliability of the detection result is high.

Unlike the case of a face, an eye is a relatively small region, so there area few cases in which an eye cannot be detected. Particularly, in the case of red-eyes, detection of a red eye is higher in accuracy than the detection of a normal eye, because a red eye to be detected is always open. From the foregoing described, the red eye detection device 1 is capable of accurately detecting a red eye region.

Next, processing by the red eye retouch device 2 will be briefly described. FIG. 13 shows an overview of the processing by the red eye retouch device 2 of FIG. 1. As shown in the figure, in the first embodiment, the red eye retouch device 2 extracts a pixel whose color difference Cᵣ exceeds a predetermined value, from the red eye region decided by of the red eye decision section 4 the red eye detection device 1. Then, the red eye retouch device 2 shapes the region by a morphology process and replaces the color of each pixel constituting the shaped region with a color suitable as the color of the pupil of an eye, such as gray with predetermined brightness.

According to the above-described red eye detection process and red eye retouch process, red eye can be detected and retouched with a high degree of accuracy without having recourse to human intervention. Therefore, the red eye detection device of the present invention is very useful in an environment where it is difficult to specify a region that needs to be retouched. For example, if the red eye detection device of the present invention and the aforementioned red eye retouch device are produced integrally as a semiconductor device and are mounted in a device, in which the screen is small and it is difficult to specify a region in an image, such as a portable telephone with a built-in camera, a high-quality image can be obtained in which red eye is corrected in an environment where the correction of red eye could not be made.

Note that the red eye detection device, red eye detection method, and red eye detection program of the present invention are characterized in that a red eye region is decided by detecting a candidate based on a feature of a narrow region like the pupil of an eye, then detecting an eye smaller than a face but greater than the pupil, and checking whether the candidate is a true red eye region. Therefore, the setting of a red eye candidate region and the identification process are not limited to the above-described embodiment. For example, the identification process may be performed by employing other well-known methods.

### Second Embodiment

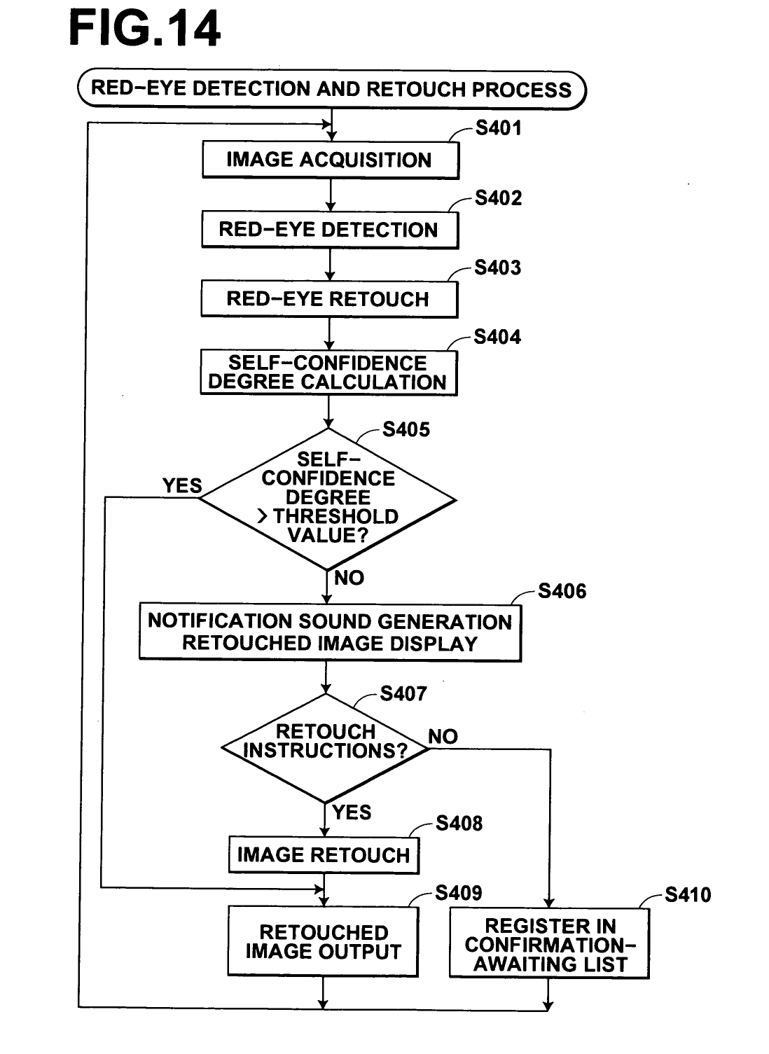

Next, a description will be given of an image processing device for correcting red eye that is equivalent to a second embodiment of the present invention. This image processing device is equipped with a red eye detection function, a red eye retouch function, and a function of supporting a red eye retouching operation by an operator. FIG. 14 shows a red eye detection process and red eye retouch process to be performed by this image processing device.

As shown in the figure, the image processing device acquires an image on which a red eye detection process and correction process are to be performed (S401). The image is acquired by reading out data from a storage medium such as a hard disk, etc. Subsequently, the image processing device performs a red eye detection process (S402) and a red eye retouch process (S403) on the acquired image.

The red eye detection process in step S402 is the same process as that carried out by the red eye candidate detection section 3 of the first embodiment. However, the same process as a process combining the functions of the red eye candidate detection section 3 and red eye decision section 4 of the first embodiment together may be performed. In addition, red eye may be detected by a process differing from the process shown in the first embodiment.

The red eye retouch process in step S403 is the same process as that carried out by the red eye retouch device 2 of the first embodiment. However, red eye may be retouched by a process differing from the process shown in the first embodiment.

Subsequently, the degree of confidence of the red eye detection-retouch process is calculated (S404). The degree of confidence used herein is an index representing whether red eye detection is accurately performed, or whether an image is suitably retouched.

In step S405, when the calculated degree of confidence is judged to be greater than a predetermined threshold value, the image retouched in step S403, as it is, is output in step S409.

In step S405, when the calculated degree of confidence is judged to be less than the predetermined threshold value, the image processing device generates a notification sound and also displays the image retouched in step S403 on the display screen thereof (S406). When retouch instructions from an operator are input (S407), the image is retouched according to the instructions (S408) and the retouched image is output (S409).

On the other hand, when there is no input from an operator, the image retouched in step S403 is registered in a confirmation awaiting list, along with the unretouched image and the detection result obtained in step S402 (S410). If the above-described red eye detection process and retouch process are completed, the image processing device returns to step S401, acquires the next image, and repeats the red eye detection process and retouch process.

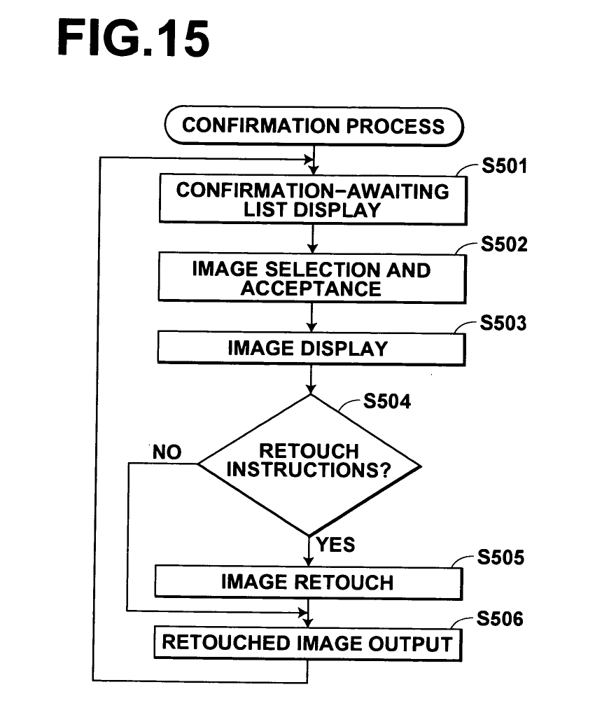

FIG. 15 shows the process of confirming images that are registered in the confirmation awaiting list. As shown in the figure, the image processing device first displays the confirmation awaiting list on the screen (S501). If an operator selects an image from the list, the selection is accepted (S502) and the selected image is displayed on the screen (S503). When retouch instructions from the operator are input (S504), the image is retouched according to the instructions (S505) and the retouched image is output (S506). When there are no instructions from the operator, the retouched image, obtained in step S403 of FIG. 14 and stored in step S411, is output as it is.

As evident from the foregoing description, when the degree of confidence of the red eye detection-retouch process is high, the process automatically outputs a retouched image without having recourse to operator's intervention. On the other hand, when the degree of confidence is low, a notification sound demanding operator's intervention is generated and retouch instructions from an operation are accepted. The image processing device also has the function of registering an image in the confirmation awaiting list and confirming it later, in such a way that when an operator cannot retouch the image immediately, it can be retouched later.

Therefore, the operator does not need to judge whether intervention is needed, while confirming all images one by one. Only when a notification sound is generated, attention may be paid to an image. In addition, since images are registered in the list and can be processed later, operation can be performed at my own convenience. This can considerably lessen the burden of the operator.

Next, the degree of confidence calculation process in step S404 will be described. In the second embodiment, a degree of confidence is calculated by making use of an identification point calculated in the red eye detection process. As previously described, in the red eye detection process, when an identification point is greater than the threshold value i, an image is judged to be red eye. When it is less than the threshold value i, an image is judged a non-red eye. In this method, when the difference between the identification point and the threshold value is great, the degree of confidence of the result of judgment is considered high, compared with the case where the difference is small. Therefore, if a degree of confidence is previously defined so that it becomes high when the difference is great and becomes low when the difference is small, a degree of confidence representing the reliability of detection can be obtained after the detection process.

Subsequently, the judgment process in step S405 will be described. In step S405, as previously described, the judgment of whether the calculated degree of confidence is greater than the predetermined threshold value is made. The threshold value may be a fixed value, but the influence of misdetection and misretouch depends on applications in which images are used. Therefore, in the second embodiment, the aforementioned judgment is made based on a threshold value optimally set according to applications in which images are used.

For instance, when a red eye corrected image is printed, misdetection and misretouch are more easily conspicuous as the size of a print becomes greater. Therefore, in the second embodiment, the threshold value is set higher as the size of a print becomes greater.

Also, even when the size of a print is not great, misdetection and misretouch are similarly conspicuous in a photograph in which the face of a person is scaled up, or in an image in which the ratio of a red eye region is great. In such a case, the threshold value is set high.

Furthermore, in the case where images recorded on film are digitized and achieved in a storage medium, there is a possibility that the images will be utilized in applications of every variety. Therefore, in such a case, the aforementioned judgment is made based on a high threshold value so that even when images are utilized in any application, the influence of misdetection or misretouch is negligible.

In the process of step S406, the image processing device of the second embodiment generates a notification sound and displays a retouched image on the screen. However, other processes may be performed if they can arouse operator's attention. For example, instead of a sound, there is a method of arousing operator's attention by blinking the entire screen. Also, a method of notification may be varied in stages according to a degree of confidence. For instance, sound volume may be varied according to a degree of confidence, or the time to await retouch instructions may be varied according to a degree of confidence by displaying on the screen.

Next, the processes in steps S407 and S408 will be described. Retouch instructions from users are as follows. One example is instructions to remove misdetection. In the second embodiment, when an electrical decoration which is not a red eye, for example, is detected and retouched to the color of an eye, means to specify a desired region on the screen, a menu for inputting instructions to cancel retouch, buttons, etc., are displayed on the screen so that users can request retouch. The second embodiment also provides the function of directly retouching a part retouched in error by users.

The second embodiment further provides the function of performing automatic retouch by directly specifying a red eye missed by detection on the screen and giving retouch instructions, or by specifying a region that contains a red eye missed by detection and performing the red eye detection process on the specified region. Alternatively, the red eye detection process and red eye correction process may be automatically carried out again without specifying a region. If the detection process is performed by setting the threshold value of an identification point low, the number of red-eyes detected will increase and therefore undetected red-eyes can be reduced.

In outputting a retouched image in step S409, an image obtained by directly rewriting the image acquired in step S401 maybe output, or differential information between the original image and a retouched image may be output. In the case of the latter, a retouched image is formed by synthesizing the original image the differential information in a device (a printer, etc.) that makes use of the result.

### Third Embodiment

Next, a description will be given of a system comprising a first image processing device equivalent to a third embodiment of the present invention and a second image processing device differing from the first image processing device. The first image processing device is equipped with the function of detecting red eye and the function of supporting a red eye retouch operation. The second image processing device is equipped with the function of retouching red eye.

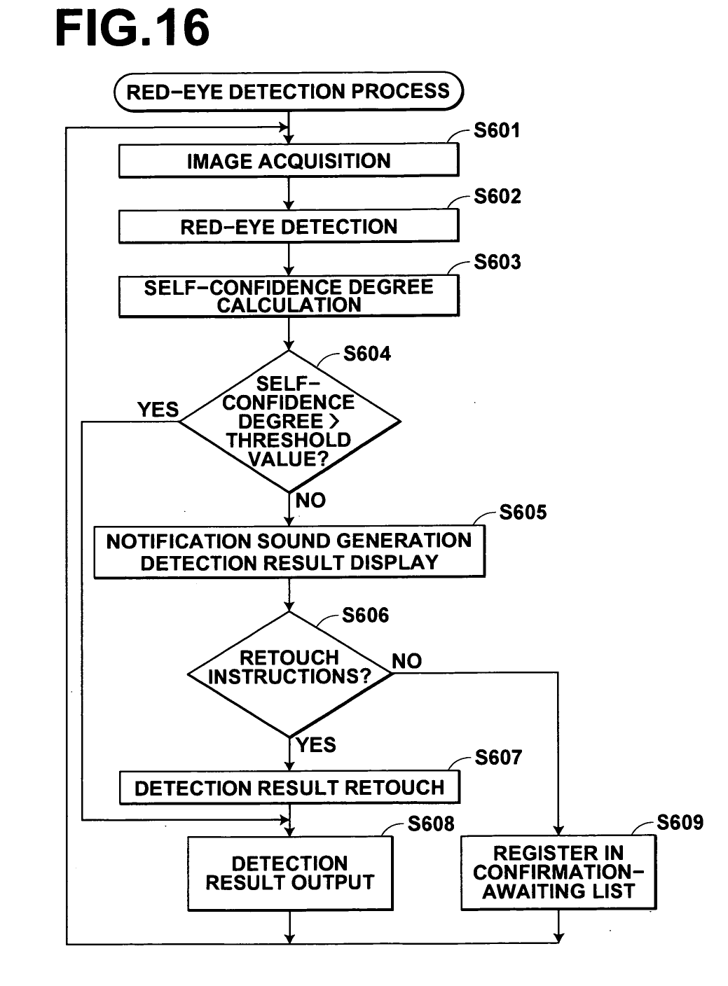

FIG. 16 shows a red eye detection process to be carried out by the first image processing device of the third embodiment of the present invention. As shown in the figure, the first image processing device acquires an image on which a red eye detection process is to be performed (S601). The image is acquired by reading out data from a storage medium such as a hard disk, etc. Subsequently, the red eye detection process is automatically performed on the acquired image (S602).

Subsequently, the degree of confidence of the red eye detection process is calculated (S603). In step S604, when the calculated degree of confidence is judged to be greater than a predetermined threshold value, the result detected in step S602, as it is, is output in step S608.

In step S604, when the calculated degree of confidence is judged to be less than the predetermined threshold value, the first image processing device generates a notification sound and also displays red eye detection result, such as the position and size of a red eye detected in step S602, on the display screen thereof (S605). When retouch instructions from an operator are input (S606), the detection result is retouched according to the instructions (S607) and the retouched detection result is output (S608).

On the other hand, when there is no input from an operator, the image on which the red eye detection process has been performed in step S602 is registered in a confirmation awaiting list, along with the detection result (S609). If the above-described red eye detection process and retouch process are completed, the first image processing device returns to step S601, acquires the next image, and repeats the red eye detection process and retouch process.

FIG. 17 shows the process of confirming images that are registered in the confirmation awaiting list. As shown in the figure, the first image processing device first displays the confirmation awaiting list on the screen (S701). If an operator selects an image from the list, the selection is accepted (S702) and the result of the red-detection process performed on the selected image is displayed on the screen (S703). When retouch instructions from the operator are input (S704), the image is retouched according to the instructions (S705) and the retouched detection result is output (S706). When there are no instructions from the operator, the detection result obtained in step S702 of FIG. 16 is output as it is.

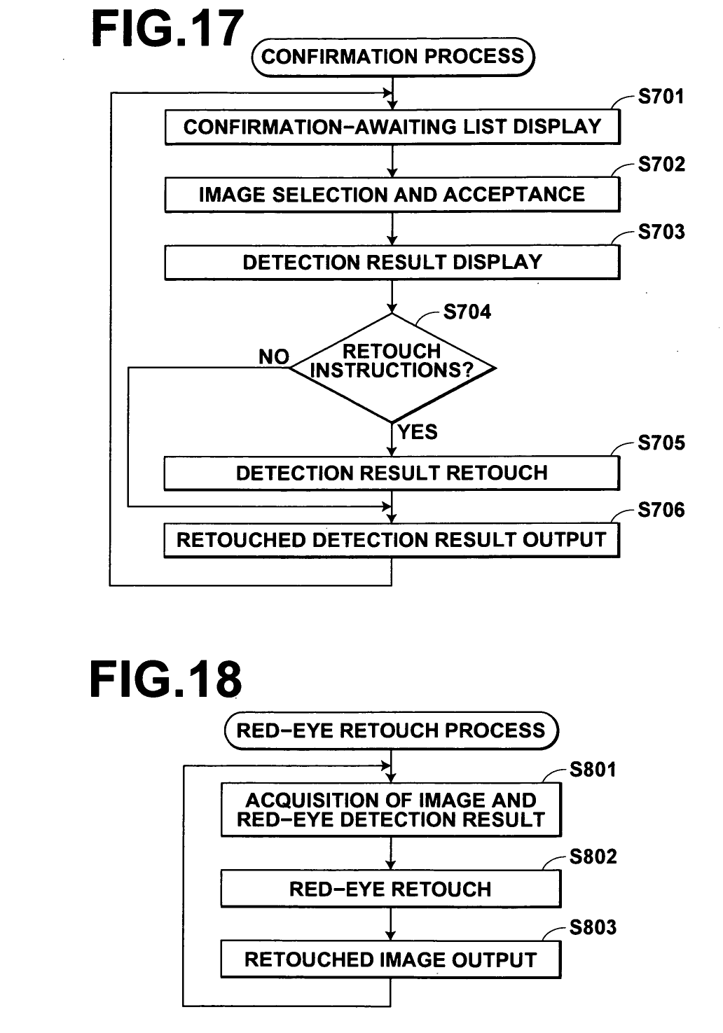

FIG. 18 shows a red eye retouch process to be performed by the second image processing device of the third embodiment. As shown in the figure, the second image processing device acquires the image and red eye detection result that are output by the first image processing device (S801). And the second image processing device retouches the detected red-eye (S802) and outputs a retouched image (S803).

Because the method of detecting and retouching red eye and the method of calculating a degree of confidence are the same as those of the second embodiment, a description of the methods is omitted.

In the second embodiment, a user confirms an automatically retouched image and then inputs retouch instructions. In the third embodiment, at the stage of only the result of detection before an image is retouched, a user is urged to confirm the image when the degree of confidence is low. Before the retouch process is performed on an image, an operator is caused to retouch misrecognition. Therefore, the third embodiment can reduce a burden imposed on the device, compared with the second embodiment.

### Fourth Embodiment

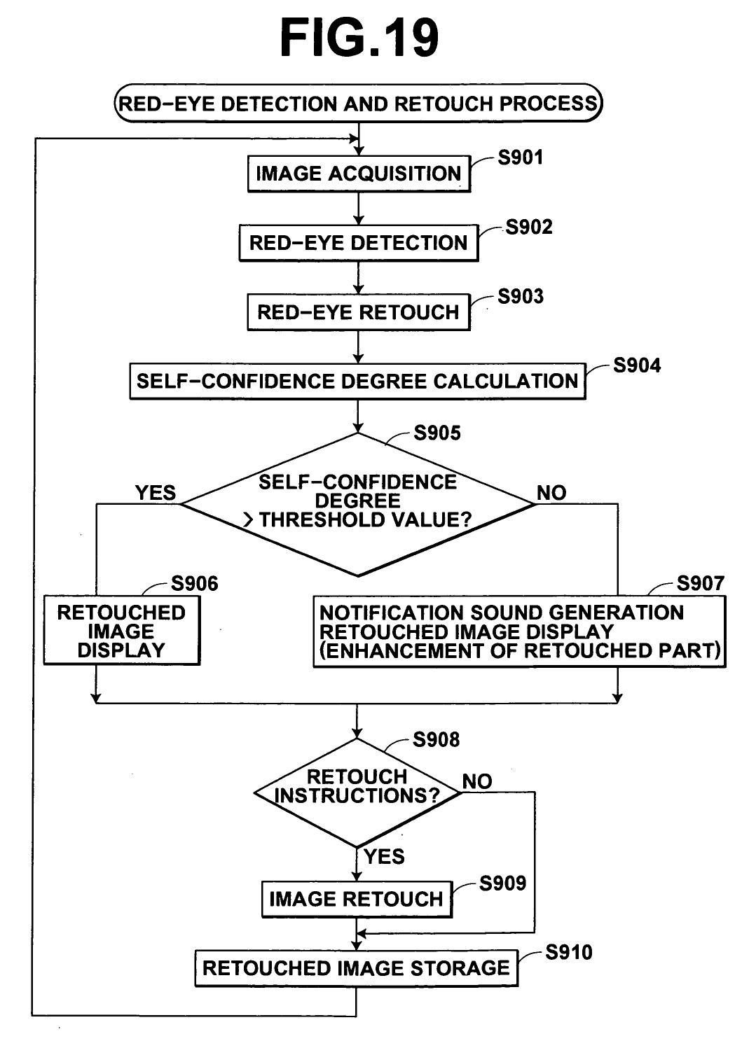

Next, a description will be given of a digital camera with a built-in function of supporting a red eye retouch operation that is constructed in accordance with a fourth embodiment of the present invention. FIG. 19 shows a red eye detection process and red eye retouch process to be executed by the digital camera.

As shown in the figure, the digital camera acquires an image on which a red eye detection process and a red eye retouch process are to be performed (S901). Subsequently, the digital camera performs the red eye detection process (S902) and red eye retouch process (S903) on the acquired image.

Subsequently, the degree of confidence of the red eye detection process and retouch process is calculated (S904). In step S905, when the calculated degree of confidence is judged to be greater than a predetermined threshold value, the retouched image is output to the liquid crystal monitor of the digital camera (S906).

In step S905, when the calculated degree of confidence is judged to be less than the predetermined threshold value, the digital camera generates a notification sound and also displays the image retouched in step S903 on the screen thereof. Since the screen of the digital camera is small in size, confirmation is difficult. For that reason, confirmation is made easier by enhancing a retouched part with a frame or displaying a retouched part on an enlarged scale (S907).

When retouch instructions from an operator are input (S908), the image is retouched according to the instructions (S909) and the retouched image is output (S910).

On the other hand, when there is no input from an operator, the image retouched in step S903, as it is, is stored as a retouched image (S910). If the above-described red eye detection process and retouch process are completed, the digital camera returns to step S901, acquires the next image, and repeats the red eye detection process and retouch process.

Because the method of detecting and retouching red eye and the method of calculating a degree of confidence are the same as those of the second embodiment, a description of the methods is omitted.

In the case of digital cameras, particularly when the screen is small, it is difficult to judge whether an image needs to be retouched. For that reason, if images requiring retouch and images not requiring retouch can be automatically separated based on the degree of confidence of the detection process, as in the third embodiment, a burden on users is lessened.

Variations and Additional Matters

Although the image processing devices and the digital camera have been described as the preferred embodiments of the present invention, the aforementioned functions of the present invention are realized by software programs. Therefore, the present invention is not limited in hardware appearance and size. All devices, equipped with storage means for storing programs and image data and arithmetic means for carrying out the stored programs, can be the red eye detection device of the present invention by installing the red eye detection program of the present invention.

For instance, if the red eye detection program is installed in a general-purpose computer equipped with a CPU, memory, a hard disk, and other input/out interfaces, the general-purpose computer can function as the red eye detection device of the present invention.

In addition, when a dedicated machine like a digital photograph printer can install and carry out the red eye detection program of the present invention, the red eye detection function can be added to that machine.

The red eye detection device of the present invention can also be formed as a memory-logic mounted semiconductor device. In this case, a device having the semiconductor device can also function as the red eye detection device of the present invention.

Thus, the red eye detection device of the present invention can have various appearances and hardware constructions, so the present invention is not limited in appearance and construction.

The occurrence of red eye and the color of an eye depend on the structure of the eye in addition to the illumination during photographing. For example, the eye of a nocturnal animal gleams more easily than a human eye, because it has a tapetum for reflecting light behind the retina. In the case of reflection at the tapetum, the eye is often photographed in yellow green other than red. Thus, in the case where an eye gleams due to a different cause, or even in the case of eyes other than red eyes, the present invention is applicable.

1. A device for detecting, from an image that contains the pupil of an eye having a red eye region, said red eye region, said device comprising:
a red eye candidate detection section for detecting one or more red eye candidate regions that can be estimated to be said red eye region, by identifying at least one of the features of said pupil from among features of said image; and
a red eye decision section for identifying at least one of the features of a face region with a predetermined size that contains said pupil, from a region containing only one of said red eye candidate regions detected by said red eye candidate detection section and wider than said one red eye candidate region, and for deciding said red eye candidate region as a red eye region, based on a result of the identification;
wherein information on said red eye candidate region decided as a red eye region by said red eye decision section is output as information on the detected red eye region.

2. The device as set forth in claim 1, wherein said face region has a dimension of five times said red eye region contained in said face region, in at least one direction.

3. The device as set forth in claim 1, wherein said face region is formed into a size that contains contours of an eye.

4. The device as set forth in claim 1, wherein said red eye candidate detection section and/or said red eye decision section identifies said feature in a color space that has an axis representing a color difference between red color and flesh color.

5. A method of detecting, from an image that contains the pupil of an eye having a red eye region, said red eye region, said method comprising:
a red eye candidate detection step of detecting one or more red eye candidate regions that can be estimated to be said red eye region, by identifying at least one of the features of said pupil from among features of said image;
an identification step of identifying at least one of the features of a face region with a predetermined size that contains said pupil, from a region containing only one of said detected red eye candidate regions and wider than said one red eye candidate region;
a decision step of deciding said red eye candidate region as a red eye region, based on a result of the identification; and
an output step of outputting information on said red eye candidate region decided as a red eye region, as information on the detected red eye region.

6. The method as set forth in claim 5, wherein said face region has a dimension of five times said red eye region contained in said face region, in at least one direction.

7. The method as set forth in claim 5, wherein said face region is formed into a size that contains contours of an eye.

8. The method as set forth in claim 5, wherein in said red eye candidate detection step and/or said red eye decision step, said feature is identified in a color space that has an axis representing a color difference between red color and flesh color.

9. A computer-readable recording medium having a red eye detection program, for causing a computer to carry out a process of detecting, from an image that contains the pupil of an eye having a red eye region, said red eye region, recorded therein, said program further causing said computer to carry out:
a red eye candidate detection process of detecting one or more red eye candidate regions that can be estimated to be said red eye region, by identifying at least one of the features of said pupil from among features of said image;
a red eye decision process of identifying at least one of the features of a face region with a predetermined size that contains said pupil, from a region containing only one of said detected red eye candidate regions and wider than said one red eye candidate region, and of deciding said red eye candidate region as a red eye region, based on a result of the identification; and
an output process of outputting information on said red eye candidate region decided as a red eye region, as information on the detected red eye region.

10. The recording medium as set forth in claim 9, wherein, in said red eye decision process, said face region has a dimension of five times said red eye region contained in said face region, in at least one direction.

11. The recording medium as set forth in claim 9, wherein, in said red eye decision process, said face region is formed into a size that contains contours of an eye.

12. The recording medium as set forth in claim 9, wherein, in said red eye candidate detection process and/or said red eye decision process, said feature is identified in a color space that has an axis representing a color difference between red color and flesh color.

13. A device with a function of supporting an operation of detecting from an image red eye in which at least part of the pupil of an eye is displayed red and retouching color of said red-eye, said device comprising:
an automatic red eye detection section for automatically detecting said red-eye;
a degree of confidence calculation section for calculating a degree of confidence of a result of the detection of said red-eye obtained by said automatic red eye detection section; and
a process selection execution section for selecting and executing one process from among a plurality of processes, for obtaining a red eye retouched image, which are different in content of operation to be performed by a user;
wherein said process selection execution section selects a process in which an operation burden on said user is lower, as said degree of confidence becomes higher.

14. The device as set forth in claim 13, wherein said process selection execution section selects and executes a process of requesting said user to perform an operation of confirming said detection result and/or retouched image, when said degree of confidence calculated by said degree of confidence calculation section is lower than a predetermined threshold value.

15. The device as set forth in claim 13, wherein said process to request said user to perform the confirmation operation is a process of outputting a predetermined speech sound.

16. The device as set forth in claim 13, wherein said process selection execution section selects and executes a process of registering said image in a predetermined list, when said degree of confidence calculated by said degree of confidence calculation section is lower than a predetermined threshold value.

17. A computer-readable recording medium with a red eye detection program for causing a computer to carry out a process of supporting an operation of detecting from an image red eye in which at least part of the pupil of an eye is displayed red and retouching color of said red-eye, said program further causing said computer to function as:
an automatic red eye detection section for automatically detecting said red-eye;
a degree of confidence calculation section for calculating a degree of confidence of a result of the detection of said red-eye obtained by said automatic red eye detection section; and
a process selection execution section for selecting and executing one process from among a plurality of processes, for obtaining a red eye retouched image, which are different in content of operation to be performed by a user;
wherein said process selection execution section is caused to function so as to select a process in which an operation burden on said user is lower, as said degree of confidence becomes higher.

18. The recording medium as set forth in claim 17, wherein said process selection execution section selects and executes a process of requesting said user to perform an operation of confirming said detection result and/or retouched image, when said degree of confidence calculated by said degree of confidence calculation section is lower than a predetermined threshold value.

19. The recording medium as set forth in claim 17, wherein said process to request said user to perform the confirmation operation is a process of outputting a predetermined speech sound.

20. The recording medium as set forth in claim 17, wherein said process selection execution section selects and executes a process of registering said image in a predetermined list, when said degree of confidence calculated by said degree of confidence calculation section is lower than a predetermined threshold value.
